(19) United States
(12) Patent Application Publication
(10) Pub. No.: US 2022/0120976 A1
(43) Pub. Date: Apr. 21, 2022

(54) System, Device and Method for Aligning and Attaching Optical Fibers

(71) Applicants: Thomas Palone, Rochester, NY (US); Stefan F. Preble, Pittsford, NY (US)

(72) Inventors: Thomas Palone, Rochester, NY (US); Stefan F. Preble, Pittsford, NY (US)

(21) Appl. No.: 17/424,789

(22) PCT Filed: Jan. 24, 2020
(86) PCT No.: PCT/US2020/015044

§ 371 Date: Jul. 21, 2021

Related U.S. Application Data
(60) Provisional application No. 62/796,332, filed on Jan. 24, 2019.
(60) Provisional application No. 62/796,324, filed on Jan. 24, 2019.
(60) Provisional application No. 62/796,316, filed on Jan. 24, 2019.

(51) Int. Cl. G02B 6/36

(52) U.S. Cl. CPC G02B 6/3652

(57) ABSTRACT

Systems, devices and methods useful for aligning and attaching optical fibers and optical fiber ribbons to a photonic integrated circuit.

### CROSS REFERENCE

This application claims the benefit of the filing date of U.S. Provisional Patent Application No. 62/796,332, filed Jan. 24, 2019; U.S. Provisional Patent Application No. 62/796,324, filed Jan. 24, 2019; and U.S. Provisional Patent Application No. 62/796,316, filed Jan. 24, 2019, which are each hereby incorporated by reference in their entirety.

This invention was made with government support under grant number FA8650-15-2-5220 awarded by the Department of Defense. The government has certain rights in this invention.

### FIELD

Systems, devices and methods useful for aligning and attaching optical fibers and optical fiber ribbons to a photonic integrated circuit.

### BACKGROUND

Attaching and aligning multiple fibers to a photonic integrated circuit (PIC) at a cost-effective assembly rate is a big challenge. A photonic integrated circuit (PIC) is manufactured using the same processing equipment that is ubiquitous in the electronic integrated circuit world and as a result offers the promise of integrating photons into a wide range of applications (computing, communication and sensing). However, packaging of PIC die is an ongoing challenge. Specifically, various integrated circuit (IC) packaging methods exist for interfacing the electrical signals on the die, such as, wire bonding, ball grid array (BGA) packaging and advanced methods like through-silicon-via's (TSV's). With a PIC die, the equivalent connection to the outside world is with an optical fiber. These delicate fibers need to be precisely positioned to optical waveguides on the die and attached in a robust method. The means of attachment must both prevent damage to the fiber and maintain efficient power coupling of the signal to the optical circuit. The PIC chips take two general approaches for coupling light to/from fibers: edge coupling and surface gratings. Surface gratings have a bit more forgiveness with respect to position but require more area of the die surface. In the edge coupling approach, numerous implementations exist in research. These include active alignment with no constraints, to V grooves and U channels targeting a more cost-effective passive alignment approach. The art lacks effective methods and apparatus which overcome the noted deficiencies in the state of the art.

### SUMMARY

In accordance with another aspect of the present disclosure, there is provided an optical fiber vacuum gripping tool, including: a first side plate including a first planar edge surface and a first planar side surface; a first fiber datum shim including at least one vacuum passage disposed therein, a second planar side surface adjacent the first planar side surface and a first fiber datum edge surface, the first at least one vacuum passage having a first at least one vacuum passage opening at the first fiber datum edge surface; a second side plate including a third planar side surface adjacent the second planar side surface and a second planar edge surface aligned with the first planar edge surface; and a first at least one vacuum source port in fluid communication with the first at least one vacuum passage and disposed in at least one of the first side plate and second side plate, wherein the first fiber datum edge surface is recessed below the aligned first and second planar edge surfaces.

In accordance with one aspect of the present invention, there is provided an optical fiber vacuum gripping tool, including: a first side plate including a first planar edge surface and a first planar side surface, wherein the first planar side surface includes a first at least one vacuum passage disposed therein and a first fiber datum edge surface, the first at least one vacuum passage having a first at least one vacuum passage opening at the first fiber datum edge surface; a second side plate including a second planar side surface adjacent the first planar side surface and a second planar edge surface aligned with the first planar edge surface; and a first at least one vacuum source port in fluid communication with the first at least one vacuum passage and disposed in at least one of the first side plate and second side plate, wherein the first fiber datum edge surface is recessed below the aligned first and second planar edge surfaces.

In accordance with another aspect of the present disclosure, there is provided an optical fiber vacuum gripping tool, including an integrated ribbon substrate recess; a removeable ribbon coupon disposed in the recess; and a UV transparent recess cover.

In accordance with another aspect of the present disclosure, there is provided a multiple fiber ribbon, including a flat datum surface of the multiple fiber ribbon including precision microspheres disposed in the adhesive of the fiber array defining an optical fiber axis from the datum surface having a diameter which matches a mating component of a photonic integrated chip vertically aligning the optical fiber axis.

In accordance with another aspect of the present disclosure, there is provided a method for aligning and attaching optical fibers to a photonic integrated chip, including: loading a gripper tool with a plurality and spacing of fibers matching the number and spacing of waveguides on a photonic integrated chip; retaining a precise position of the fibers on the tool by vacuum; monitoring the coupling of light between the optical fibers and the photonic integrated chip; manipulating the position of the optical fibers axis and faces in proximity with the optical axis of the waveguides on the photonic integrated chip; and optically coupling the fibers using feedback from the monitoring.

In accordance with another aspect of the present disclosure, there is provided a method for forming an optical fiber array, including: loading a plurality of optical fibers into locating features on a ribbon forming tool including a coupon component; retaining the loaded optical fibers in the coupon component of the ribbon forming tool by vacuum at a precise spacing and planarity of the optical fibers; applying an adhesive material to the optical fibers retaining their relative position forming a fiber optic ribbon array; and cleaving the fibers of the ribbon array at an optical interface of the optical fibers.

In accordance with another aspect of the present disclosure, there is provided a method for photo fabrication of an array of optical fibers, including: precision cleaning a metal substrate in the form of a single sheet or a roll; laminating with a photoresist material on one or both planer surfaces of the metal substrate; positioning photo tool masters of the desired components geometry, opposite one or both planar surfaces of the photo-resist laminated metal; precisely aligning the photo tools via integral fiducials and the desired components geometry then imaged (exposed) on one or both planar surfaces of the metal substrate being processed; developing and baking the laminated photoresists on the metal substrate resulting in photoresist protecting the metal substrate in areas of the desired components geometry; subjecting the laminated metal substrate to an etching process, attacking the unprotected base metal wherein opposing un-protected regions existing on both planar surfaces of the substrate, and etching from both sides, eventually perforating the metal substrate in that region; and retaining small sprue-like features around the perimeter of the desired geometry to retain the component in the sheet or roll of metal substrate to be broken out at a later time, wherein when only one side of the substrate has an un-protected region, only etching from that side and its penetration depth determined by the time exposed to the etching process resulting in a half etch feature in the metal substrate.

In accordance with another aspect of the present disclosure, there is provided a method for passive alignment and attachment of an optical fiber array to a photonic integrated chip, including: incorporating a plurality of microspheres in the adhesive of an optical fiber array where a surface of the circumference the optical fibers is in intimate contact with a flat surface, defining the fibers optical axis plane parallel to that flat surface by the inherent precision of the optical fibers diameter when forming the optical fiber array, the optical fibers in the array have an axis parallel in one plane and precisely spaced by the features of the array forming fixture in another plane; aligning the optical fibers with waveguides of a photonic circuit residing at a precise distance below the surface of the chip; and optically coupling these optical axis features in the vertical plane passively making the connection of the fiber array to the photonic integrated chip.

These and other aspects of the present disclosure will become apparent upon a review of the following detailed description and the claims appended thereto.

### BRIEF DESCRIPTION OF THE DRAWINGS

FIG. 1A illustrates a single fiber vacuum gripper tool, FIG. 1B a multiple fiber tool, FIG. 1C shows the multiple fiber tool coupling fibers to a photonic integrated circuit waveguides, FIG. 1D shows a close-up of fibers in a six-fiber tool, FIG. 1E a multiple fiber tool having adjacent contacting fibers, and FIG. 1F shows a plate containing vacuum passages, ports and fiber datum surface in accordance with embodiments with the present disclosure;

FIG. 2A illustrates a front plate of a two-fiber tool and FIG. 2B shows a cross-section of the two-fiber tool;

FIG. 3A illustrates a front plate, FIG. 3B a rear plate, FIG. 3C a fiber datum shim, FIG. 3D a spacer shim, and FIG. 3E a fiber datum shim;

FIGS. 4A, 4B and 4C illustrate a formed fiber ribbon or array on a variety of coupons;

FIG. 5A illustrates a perspective view of a ribbon forming fixture, FIG. 5B shows a top view of the ribbon forming fixture, and FIG. 5C shows UV curing of the array;

FIGS. 6A and 6B illustrate an embodiment of a ribbon forming fixture for multiple adjacent fibers and FIGS. 6C and 6D illustrate an embodiment of a ribbon forming fixture for multiple spaced apart fibers;

FIG. 6C, as in FIGS. 6A and 6B, two of the three vacuum passages 20 fed through vacuum ports 10 hold the fibers 2 at the desired pitch. The third vacuum passage 20 leads to a fiber datum surface that accurately holds a feature specific array/ribbon coupon 30. In this embodiment, the four fibers 2 are spaced apart by spacer shim 6 whose thickness defines the fiber datum shims 4 spacing, thus defining the fiber 2 spacing when on fiber datum surface 24 between either a front 12 or rear 14 plate and a spacer shim 6. To aid in loading of the fibers 2 onto the ribbon forming fixture, FIG. 6D illustrates the use of loading fins 7. Loading fins 7 have the same function as spacer shims 6, and the geometry is the same except for an extension of shim material that extends above the ribbon forming fixture which are then fanned out to facilitate easy loading of the fibers into the desired location on the ribbon forming fixture.

FIG. 7A illustrates a vacuum gripper tool having a parabolic vacuum channel, FIG. 7B shows a cross-sectional view of a polarized fiber, and FIG. 7C shows transmitting torque to a fiber;

FIG. 8A illustrates an embodiment of a vacuum gripper tool, FIG. 8B shows a vacuum port of the tool, and FIG. 8C shows the porous media of the tool;

FIG. 9A illustrates an embodiment of a narrow fiber vacuum manipulator and FIG. 9B shows a fiber held by the manipulator;

FIG. 10A illustrates a vacuum fiber array manipulator with a UV transparent window and FIG. 10B shows a cross-section of the tool;

FIG. 11A illustrates an embodiment of a photo fabricated ribbon forming component (substrate) and FIG. 11B shows a cross-section of the component;

FIG. 12A illustrates an embodiment of a photo fabricated ribbon forming component and FIG. 12B shows a folding hinge of the component;

FIG. 13A illustrates an embodiment of curing a photo fabricated ribbon forming component and FIG. 13B shows the cured array;

FIG. 14A illustrates a passive alignment of a photo fabricated ribbon forming component to a photonic integrated package using micro-sphere dispersed in the adhesive and FIG. 14B shows a cross-section of the component;

FIG. 15A illustrates a passive alignment of a photo fabricated ribbon forming component to a photonic integrated package and FIG. 15B shows a close-up of U-channels shown in FIG. 15A; and

FIG. 16A illustrates a photo fabricated fiber array mount and FIG. 16B shows a fiber array mounted to the substrate.

### DETAILED DESCRIPTION

The present disclosure provides a method of easily handling and pre-spacing optical fibers at a desired pitch while also providing mechanical stability and strain relief for the fibers. Furthermore, by adding additional features, it is possible to provide automatic alignment to one (or more) degree of freedom, which will increase assembly throughput and lower assembly costs.

Vacuum grippers for fibers and fiber arrays use vacuum channels (or features) integrated into custom fixtures to both hold and space optical fibers into controlled pitches. This brings multiple fibers together into a single fixture, enabling just one tool to align multiple fibers to a chip. The use of vacuum allows the fibers to be easily released after attachment. Multiple embodiments include: (1) Incremental fiber vacuum tool: using metal shims demonstrates the spacing and holding of multiple optical fibers with vacuum. Multiple fibers can be incrementally added (and arbitrarily spaced) by simply changing the number of shims. (2) Fiber tangency loading fiber spacing array gripper: holds fibers at a desired pitch with vacuum by using a porous vacuum block which planarizes fibers constrained between fixture edges spaced by the fiber diameter times “N” fibers. (3) Cure through vacuum fiber array gripper: the most common approach for attaching fibers to chips is with a UV curable adhesive. This method uses a vacuum gripper to hold a fiber array with an integrated glass window that allows the UV light to transmit through the gripper assembly and reach the adhesive holding the fiber array to the package.

Photo fabricated etched packages: Photoetching is commonly used to make parts using thin metal sheets of precision thickness. The packages can have: etched fiducials, foldable features for aiding alignment or adding desired stiffness, openings for vacuum to hold down components (such as the PIC chip) and half etched features to control adhesive migration. The photoetching of the features can be made with metals with a CTE well matched to silicon/glass. Similar components may also be electroformed having a limited feature set.

Specific implementations include: Etched grooves to precisely space multiple fibers together. The fibers are easily populated into a pattern with the aid of vacuum slots. Once populated, the top surface may be “glob topped” with adhesive creating a ribbon of fibers at the desired pitch. The fibers of the assembly are then cleaved by mechanical or laser procedures. A preferred embodiment is to cleave the position of the fiber ends to a datum feature that is formed or etched into the base part.

Pivot features: The photo fabricated package can incorporate pivot features which can be used to make very small adjustment of the fibers relative to the waveguide using the coarse motion of assembly equipment. This can also be used to realize surface grating coupling.

Glass bead spacers: Optical fibers have a well-defined and controlled diameter. Consequently, they can be used to determine a predictable distance to waveguides on a PIC chip. Furthermore, the waveguides on the PIC chip are at a precise distance bellow top surface of the chip. Consequently, with precisely controlled spacers it is possible to determine the relative position of an optical fiber assembly relative to the waveguides on the chip. In this method glass beads are used, which are commonly used to define adhesive bond lines in many industries. These spheres could be of any material if of consistent size: Metal for induction heating to cure adhesive, polymeric to take advantage of compressibility and high shrink rate of an adhesive to slowly cure and compress the spheres to tune in the optical connection.

Fiber vacuum chuck tools with ribbon forming features: Multiple embodiments are proposed for forming multiple optical fibers into a ribbon. All approaches utilize vacuum to hold the fibers into the tooling and aid in the spacing of the fibers. Embodiments: (1) Fiber vacuum chuck with V-grooves for spacing fibers at a desired pitch with an integrated cavity for assembling the fiber ribbon. The cavity consists of a foam for wicking the UV adhesive material and a glass cover for holding the fibers together. After curing the fibers are removed from the chuck, and then laser or mechanically cleaved. (2) Loading fins sandwiched in layers to handle desired fiber diameter and fiber-to-fiber spacing when creating ribbons or splicing fibers to a photonic chip. Vacuum channels keep fibers against a bottom datum surface and provides friction for insertion to photonic integrated chip.

Useful applications include photonic chip packaging and optical fiber packaging.

A cure-through vacuum fiber array gripper includes a glass vacuum upper envelope open to the vacuum fiber array keyway seat allowing UV light to transmit through the vacuum gripper facilitating curing of the fiber array while being held in the vacuum gripper.

A method for attaching optical fiber to photonic integrated chips includes using photo fabricated etched metal substrates to position and attach the optical fibers to the photonic integrated chips facilitating the optical connection.

A method for forming optical fibers into ribbons of well-defined pitches includes utilizing vacuum fixturing to form the ribbons.

In an embodiment, an optical fiber gripping tool can be used in a method to align and attach optical fibers to a photonic integrated chip. A gripper tool with a plurality and spacing of fibers matching the number and spacing of waveguides on the photonic integrated chip is loaded and retained in their precise position by vacuum with the types of fiber to be coupled. The coupling of light to/from the optical fibers from/to the photonic integrated chip is monitored. The amount of light is monitored using photodetector(s) either on the chip or connected to the other end of the optical fibers. The photonic chip may have an integrated laser or one or more of the optical fibers are connected to a light source (LED or laser source) of the appropriate wavelength. The gripper which may be manipulated by micro positioners or vision guided robotic/automated tooling, position the optical fibers axis' and faces in proximity with the optical axis of the waveguides on the photonic integrated chip. The fibers are precisely translated manually or under automated process control to maximize the optical coupling using feedback from photodetectors on chip or attached to the fibers. Camera systems may also be used looking at the photonic integrated chip surface's waveguide circuit.

In an embodiment, an optical fiber gripping tool having a coupon apparatus can be used to form an optical fiber array. Forming a fiber optic array or ribbon requires a fixture or substrate which defines the precise spacing and planarity of the optical fibers to be joined. Depending on the method, this structure may be an integral part of the finished fiber array or ribbon. In a clean environment, the fibers are loaded into locating features on the ribbon forming tool or substrate and retained in their precise position of the ribbon forming tool or substrate by vacuum. Once the fibers are defined in their precise positions, typically an adhesive or other material is applied to the fibers to retain their relative position. As mentioned above, the precise positioning substrate may be an integral component of the fiber array, and the applied adhesive not only bonds the fibers to one another, but also to the precise positioning substrate which increases mechanical properties of the finished array. In an embodiment, the integral component of the fiber array may be a flat surface or opening in a component that does not position the fibers, but only acts as a mechanical member or datum structure once the fibers are glued or potted on or within this integral component. In this latter situation, the precise lateral position of the fibers is defined by an external fixture and retained with vacuum. The fiber array or ribbon can be cleaved of the optical interface by various procedures, i.e., polishing, or laser cleaving.

In an embodiment, photo fabrication process can be used in a method make an array of optical fibers. The photo fabrication process may be done on a single sheet or on a roll to roll high volume machine in the following manner. All the process steps are performed in a very highly controlled environment to maintain precision. The metal substrate material is first precision cleaned and depending on the component be fabricated, laminated with a photoresist material on one or both planer surfaces. Assuming photoresist on both sides of the substrate, the next step entails positioning photo tool masters of the desired components geometry, one above and one below the photo-resist laminated metal. The photo tools are precisely aligned via integral fiducials and the desired components geometry then imaged (exposed) on both the top and bottom of the metal being processed. The laminated photoresists on the metal are then developed and baked. The resulting metal substrate now has photoresist protecting the metal in areas of the desired components geometry. The laminated metal is then subjected to the appropriate etching process, attacking the unprotected base metal. If opposing un-protected regions exist on the top and bottom of the substrate, the acid will etch from both sides, eventually perforating the metal in that region. This process defines the actual desired parts perimeter geometry. A few small sprue-like features are left around the perimeter of the desired geometry to retain the component in the sheet or roll of material to be broken out at a later time. The other scenario where only one side of the substrate has an un-protected region, the acid will only etch from that side and its penetration depth determined by the time exposed to the etching process. This type of feature is typically referred to as a half etch feature. The resulting features can provide fiducials, logo artwork, and hinge or fold lines, or other surface features.

In an embodiment, an optical fiber array or ribbon can incorporate glass feeders for alignment and attachment to a photonic integrated chip. A fiber ribbon or array where the optical fibers circumference is in intimate contact with a flat surface, define the fibers optical axis plane parallel to that flat surface because of the inherent precision of the optical fiber diameter. By incorporating this attribute when laterally defining the spacing of the optical fibers when forming the fiber ribbon or array, the fibers in the array have an axis parallel in one plane and precisely spaced by the features of the ribbon/array forming fixture in another plane. On the photonic integrated chip, the waveguides of the photonic circuit reside at a precise distance below the surface of the chip, and the waveguides spacing at the edge of the chip precisely defined by the photolithography process used in their manufacture. The end goal of optically coupling these optical axis features can further be defined in the vertical plane since the required gap between the top of the photonic integrated chip and flat surface of the fiber ribbon or array can be determined because of the attributes described above. If micro spheres of this gap size are introduced into the adhesive making the connection of the fiber array or ribbon to the photonic integrated chip, the height or vertical orientation of the optical axis, may be passively defined. The distance between the end of the optical fibers and the photonic chips' waveguides is less critical since it will be filled with index matching adhesive. The acceptance angle of the light from the fibers to waveguides is also more tolerant, leaving the precise alignment of the plurality of precisely spaced fibers and wave guides. The manipulator holding the fiber ribbon or array needs only to traverse these equally spaced features back and forth to achieve optimal coupling while referencing the vertical position of the array through the adhesive interface containing the micro spheres. This last precision degree of freedom could be eliminated by etching precision sockets in the photonic integrated chip and keying the precision fibers diameter to those sockets which were precisely created relative to the waveguides by the photolithography process.

The disclosure will be further illustrated with reference to the following specific examples. It is understood that these examples are given by way of illustration and are not meant to limit the disclosure or the claims to follow.

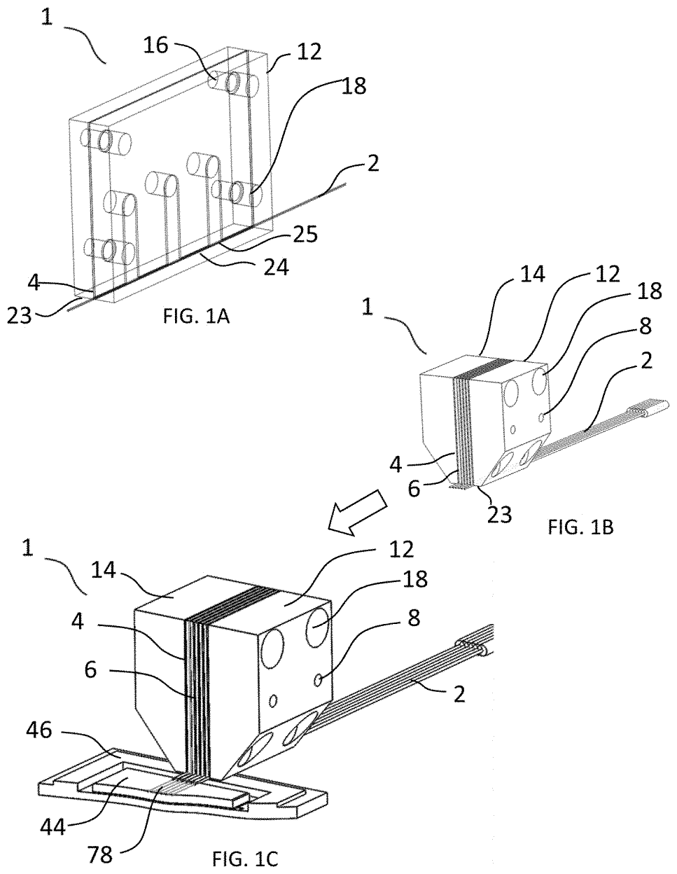

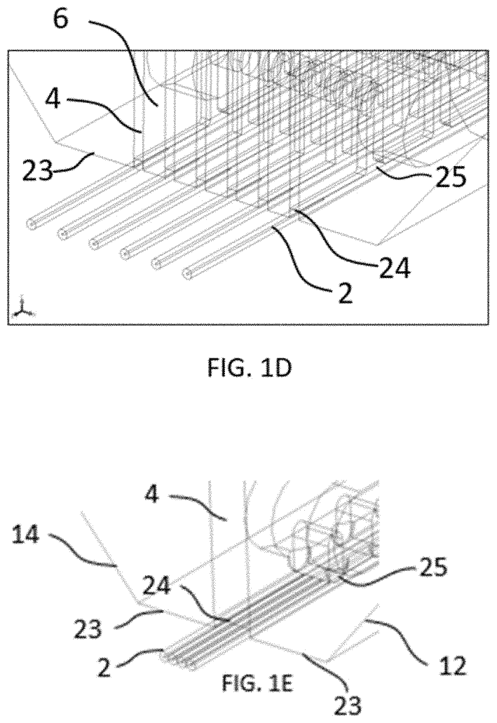

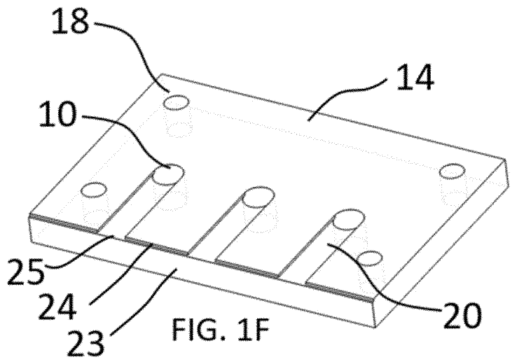

FIGS. 1A to 1F illustrate a vacuum gripper tool 1 having a front plate 12 and a rear plate 14 each with a planar edge surface 23; and a fiber datum shim 4 for fiber width positioning disposed between the front 12 and rear plates 14, including a vacuum passage 20 having an opening 25 at a fiber datum edge surface 24 thereof disposed below the planar edge surface 23. Preferably, plate and shim surfaces are planer and free from burrs, sharp edges, and contamination. Fiber datum shims 4 and spacer shims 6 can be made to precise thicknesses. Fiber datum shims can have vacuum passages 20 and clearance holes 18, and spacer shims can have vacuum ports 10 and clearance holes 18. These vacuum passages 20, vacuum ports 10, and the fiber datum surface 24 may be machined or etched into either or both of the front and rear plate side planar surfaces, if desired. One of these etched or machined front or rear plates may then be stacked together for multiple fibers and finished with a blank cover plate. This approach may be suited for a single fiber tool, a multi-fiber vacuum tool where there are large lateral spaces between fibers. Although feasible, fabrication by this method would be very costly and not flexible. The length of the plates and shims as well as the number of vacuum ports 10 and vacuum passages 20 may vary depending on the application. In an embodiment, rear plate 14 and front plate 12 are relatively thicker compared to the shim stack of fiber datum shim 4 and spacer shim 6 to provide tool planarity. This thickness also provides material thickness for assembling the tool with mechanical fasteners by way of clearance holes 18 and tapped holes 16. Mechanical fasteners allow to the tool to be reconfigured, however the tool may be laminated, welded, brazed, etc. for dedicated applications. FIG. 1A illustrates an embodiment of a single fiber tool 1. Rear plate 14 includes four tapped holes 16 and three vacuum ports 10. Clamped between rear plate 14 and front plate 12 is a fiber datum shim 4 that is 125 μm thick. This shim is for an optical fiber 2 of 125 μm diameter, if a fiber of different diameter is being used, fiber datum shims 4 thickness would be sized to that diameter. Fiber datum shim 4 includes four clearance holes 18 coinciding with the tapped holes 16 in the rear plate 14. Fiber datum shim 4 also includes three vacuum passages 20 intersecting with the three vacuum ports 10 in the rear plate 14. The three vacuum passages 20 terminate at an opening at the fiber datum surface 24 of fiber datum shim 4. Fiber datum surface 24 of fiber datum shim 4 is recessed 125 μm below the edges of the rear plate 14 and front plate 12 forming a channel for the fiber. The channel depth can be varied according to application need. Front plate 12 includes four clearances holes 18 and is applied to fiber datum shim 4 and rear plate 14 using mechanical fasteners. By suppling vacuum to vacuum ports 10 in rear plate 14, vacuum is supplied to the fiber datum surface 24 via vacuum passages 20, pulling fiber 2 into the channel of the tool. FIG. 1B illustrates a multiple fiber tool 1 with fibers 2 spaced by thickness of spacer shims 6. An infinite combination of configurations of fibers and spacing can be achieved by repeating the process described above. This is accomplished by introducing a spacer shim 6 between two fiber datum shims 4 to achieve the required fiber 2 spacing. Spacer shim 6 includes four clearance holes 18 and three vacuum ports 10 and may include alignment pins 8. FIG. 1B illustrates a tool 1 holding six fibers 2. FIG. 1C illustrates this tool 1 holding six fibers 2 (as shown in FIG. 1B) presenting and optically coupling six individual fibers 2 to the photonic integrated circuit waveguides 78 on the photonic integrated chip 44 in an electronic package 46. FIG. 1D shows a close-up of the six-fiber tool with the stack of fiber datum shims 4, spacer shims 6, and fiber datum surfaces 24 with the fibers 2 in their corresponding slots. FIG. 1E illustrates a variation with multiple fibers immediately adjacent to one another rather than spaced. In this embodiment, a single fiber datum shim 4 of a thickness equal to the fiber 2 diameter times the number of desired fibers is used. In this illustration, all four fibers 2 share a common fiber datum surface 24 on a single fiber datum shim 4. FIG. 1F illustrates an embodiment where the vacuum passages 20, vacuum ports 10, and fiber datum surface 24 are machined or etched into rear 14 plate, which can be done to either one or both of front and rear plates. The plates and shims can contain clearance holes 18 or tapped holes 16 for assembly purposes. These mounting holes may be eliminated when the components are laminated by brazing, adhesive or other methods.

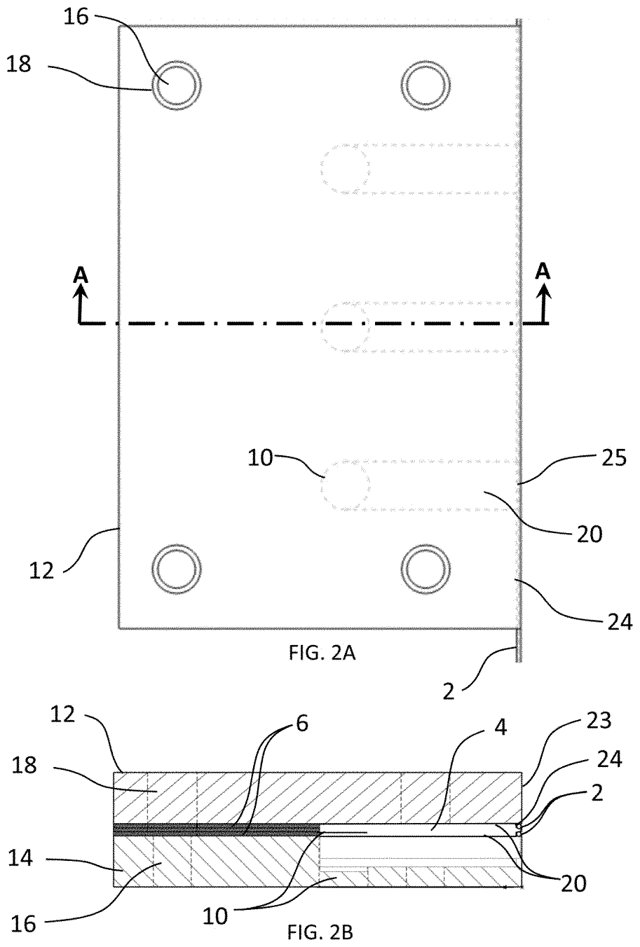

FIGS. 2A and 2B illustrate a cross-section of a two fiber 2 vacuum gripper tool having a front plate 12 and a rear plate 14; and two fiber width positioning fiber datum shims 4 separated by a spacer shim 6 disposed between the front 12 and rear plates 14, including vacuum openings 20 at an edge surface thereof disposed below the planar edge surface 23 of the front and rear plates.

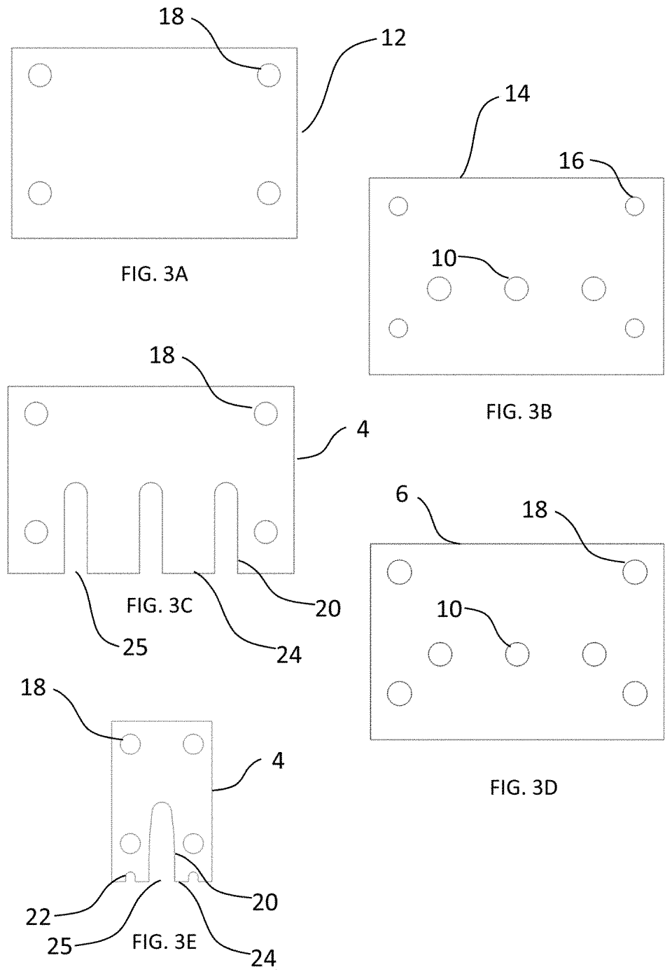

FIG. 3A-3E illustrate individual components of the tool. FIG. 3A shows a front plate 12 with four clearance holes 18. FIG. 3B shows a rear plate 14 with four tapped holes 16 and three vacuum ports 10. FIG. 3C shows a fiber datum shim 4 equal in thickness to the diameter of the fiber (or multiple fibers) 2 having four clearance holes 18 and three vacuum passages 20 terminating at openings in the fiber datum surface 24. FIG. 3D shows a spacer shim 6 equal in thickness to the desired spacing between adjacent fibers 2 tangencies and includes four clearance holes 18 and three vacuum ports 10. FIG. 3E shows a fiber datum shim 4 equal in thickness to the diameter of the fiber (or multiple fibers) 2, having a different form factor. It includes four clearance holes 18 and one vacuum passage 20 terminating at the fiber datum surface 24. An additional feature, a contamination relief 22 is shown in this embodiment, which can be incorporated in any of the fiber datum shims 4 and fiber datum surfaces 24. This feature provides a receptacle for dirt when loading fibers 2 ensuring the fiber surfaces are in contact with fiber datum surfaces 24.

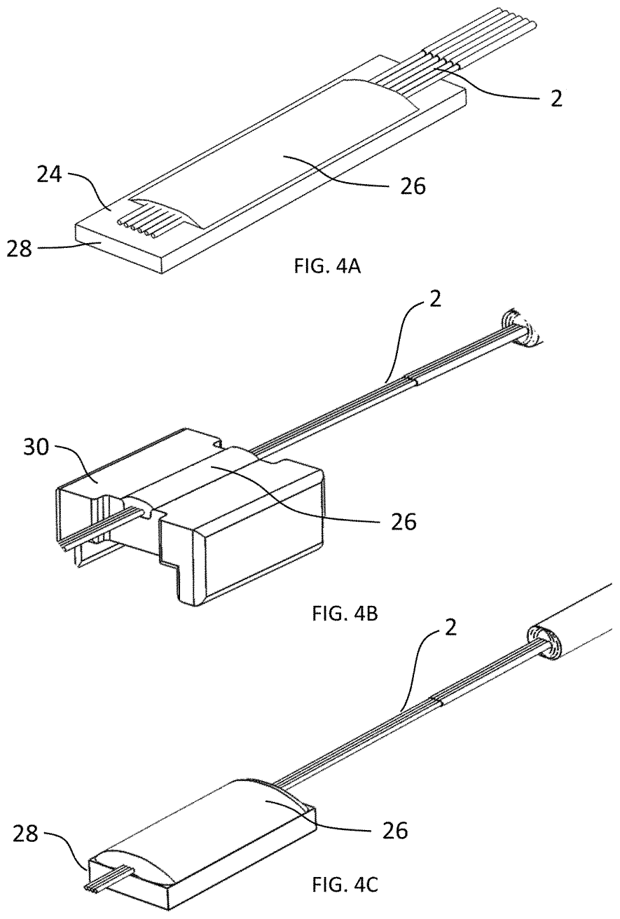

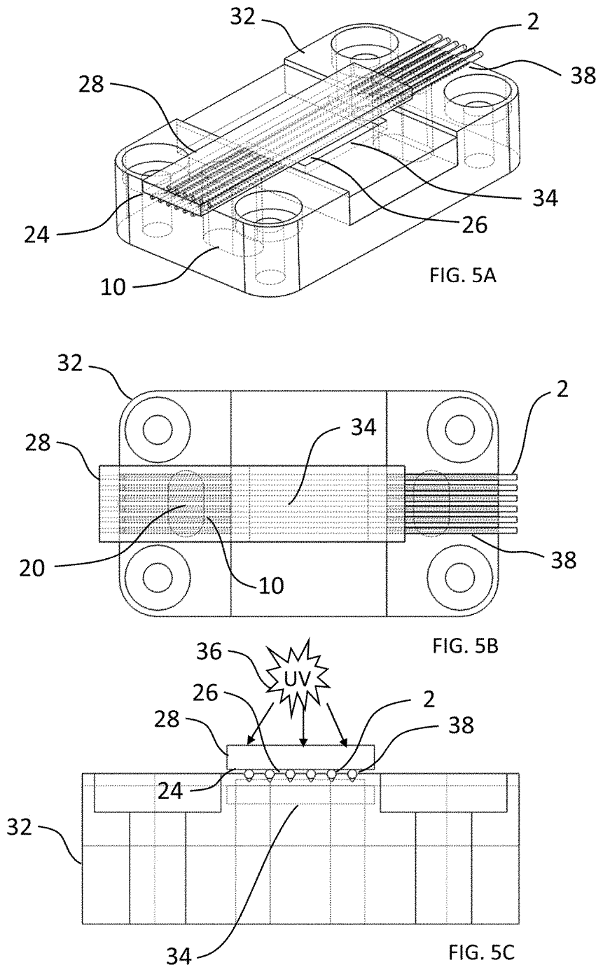

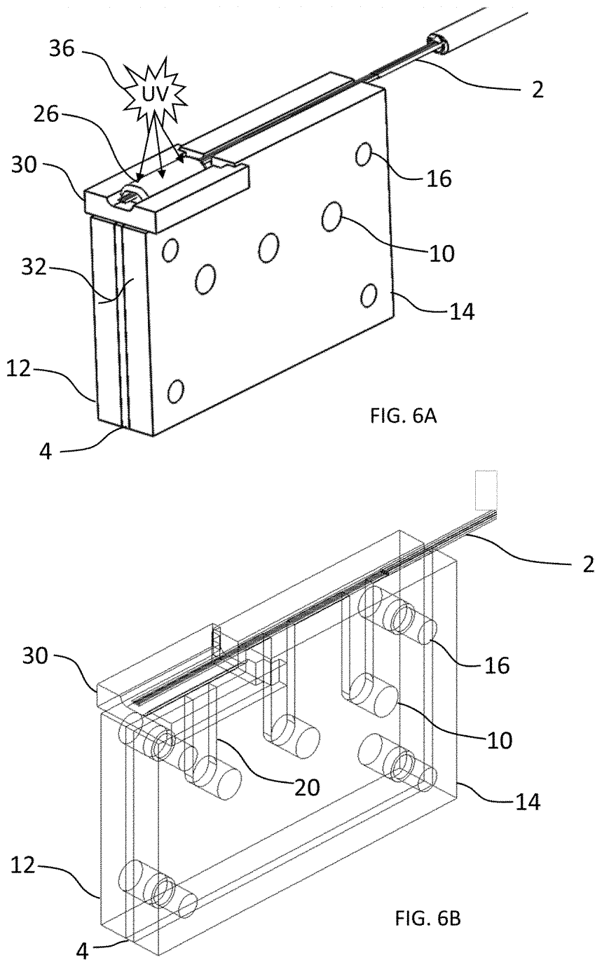

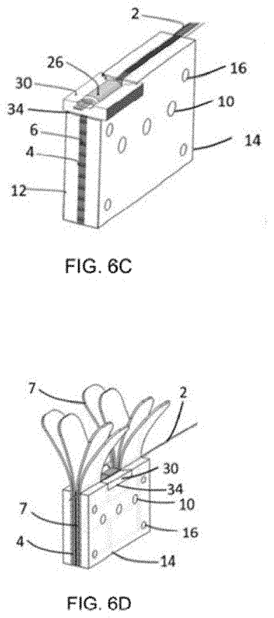

FIGS. 4A to 4C illustrate various configurations of formed fiber ribbons or arrays. The purpose of these fiber arrays is to facilitate coupling of multiple fibers to a photonic integrated chip 44 in a timely manner as opposed to one fiber at a time. These fiber arrays may have the fibers spaced so they are immediately adjacent to one another, or at some arbitrary spacing between fibers. Suitable current industry spacing standards include 250 μm and 252 μm. By using a variant of the vacuum tools described in FIGS. 1-3, custom ribbons at various spacings may be formed from individual fibers or ribbon fiber of a different pitch. These tool variants are shown in FIGS. 5 and 6. FIG. 4A shows a flat coupon 28, which may be metallic, ceramic, glass, or other low CTE material. The fibers 2 are located at the desired pitch by the vacuum gripper tools described in FIGS. 5 and 6, and their outer surfaces in contact with the coupons 28 fiber datum surface 24. The fibers 2 are retained in position by adhesive 26. The fundamental concepts are the same in FIG. 4B, except the fibers 2 position in space are relative to a feature specific array/coupon 30. The feature specific coupons 30 datum's then aid in the assembly process of the fiber ribbon arrays to the photonic integrated chip 44 or electronic package 46. Here again, the fibers are retained in position by adhesive 26. FIG. 4C shows an embodiment where only the fibers 2 spacing relative to one another are controlled and potted in adhesive 26 on a flat array/ribbon coupon 28 which can be made of various materials.

FIGS. 5A to 5C illustrate an embodiment of a ribbon forming fixture 32 containing an adhesive well or coupon holder well 34 for forming various configurations of fiber ribbons or arrays. This adhesive well or coupon holder well 34 may include features like vacuum passages or embedded magnets to hold a generic flat array/ribbon coupon 28 or feature specific array/ribbon coupon 30. Ribbon forming fixture 32 has a plurality of V grooves 38 on its top surface fed with vacuum though vacuum passages 20 which are supplied by vacuum ports 10. When adhesive well 34 is in place, fibers 2 are loaded and retained by vacuum in the V grooves 38 spanning the region over the adhesive well 34. The fibers 2 spacing are precisely controlled by the V grooves 38 and the top tangency surface of fibers 2 are above the top surface of ribbon forming fixture 32. UV adhesive 26 is dispensed into the adhesive well 34. A UV transparent flat array/ribbon forming coupons 28 fiber datum surface 24 is applied to the top of the fibers 2 on ribbon forming fixture 32. UV radiation 36 cures the adhesive 26, vacuum is turned off, and the fiber ribbon or array is removed from the ribbon forming fixture 32. The prior description involved UV adhesive for assembly time considerations, but other epoxies and adhesives may be used. The completed fiber ribbon or array is shown in FIG. 4A. The same ribbon forming fixture 32 shown in FIGS. 5A-5C may also be used to create a fiber ribbon or array as shown in FIG. 4C. In this embodiment, the adhesive well 34 is replaced with a flat array/ribbon coupon 28 of any material. The fibers 2 are loaded and retained by vacuum in the V grooves 38 spanning the region over the generic flat array/ribbon coupon 28. The fibers 2 spacing are precisely controlled by the V grooves 38. An adhesive 26 applied over the fibers 2 and onto the generic flat array/ribbon coupon 28. If UV adhesive is used, UV radiation 36 cures the adhesive 26, vacuum is turned off, and the fiber ribbon or array is removed from the ribbon forming fixture 32.

FIGS. 6A to 6D illustrate an embodiment of a ribbon forming fixture 32 made from the vacuum gripper tool, as for example described in FIGS. 1 to 3. The tool has the same functionality as the ribbon forming fixture described above in FIGS. 5A to 5C. In FIGS. 6A and 6B, two of the three vacuum passages 20 fed through vacuum ports 10 hold the multiple adjacent fibers 2 at the desired pitch. The third vacuum passage 20 leads to a fiber datum surface that accurately holds a feature specific array/ribbon coupon 30. Four immediately adjacent fibers 2 are positioned on fiber datum surface 24 of the fiber datum shim 4. The precisely loaded fibers 2 are held in position and project over or into an adhesive potting region 26 of the feature specific array/ribbon coupon 30. If UV adhesive is used, UV radiation 36 cures the adhesive 26, vacuum is turned off, and the fiber ribbon or array is removed from the ribbon forming fixture 32. This fiber ribbon or array with the feature specific array/ribbon coupon 30, then mates to a similar datum feature in the electronic package 46, simplifying optical coupling to the electronic package 46. As shown in FIG. 6C, as in FIGS. 6A and 6B, two of the three vacuum passages 20 fed through vacuum ports 10 hold the fibers 2 at the desired pitch. The third vacuum passage 20 leads to a fiber datum surface that accurately holds a feature specific array/ribbon coupon 30. In this embodiment, the four fibers 2 are spaced apart by spacer shim 6 whose thickness defines the fiber datum shims 4 spacing, thus defining the fiber 2 spacing when on fiber datum surface 24 between either a front 12 or rear 14 plate and a spacer shim 6. To aid in loading of the fibers 2 onto the ribbon forming fixture, FIG. 6D illustrates the use of loading fins 7. Loading fins 7 have the same function as spacer shims 6, and the geometry is the same except for an extension of shim material that extends above the ribbon forming fixture which are then fanned out to facilitate easy loading of the fibers into the desired location on the ribbon forming fixture. In this embodiment, two of the three vacuum passages 20 fed through vacuum ports 10 hold the fibers 2 at the desired pitch. The third vacuum passage 20 leads to a fiber datum surface that accurately holds a feature specific array/ribbon coupon 30. Here, the outer two vacuum passages 20 hold the fibers 2, and the center vacuum passage 20 leads to a fiber datum surface that accurately holds a feature specific array/ribbon coupon 30, which is now in the center residing in the coupon well 34.

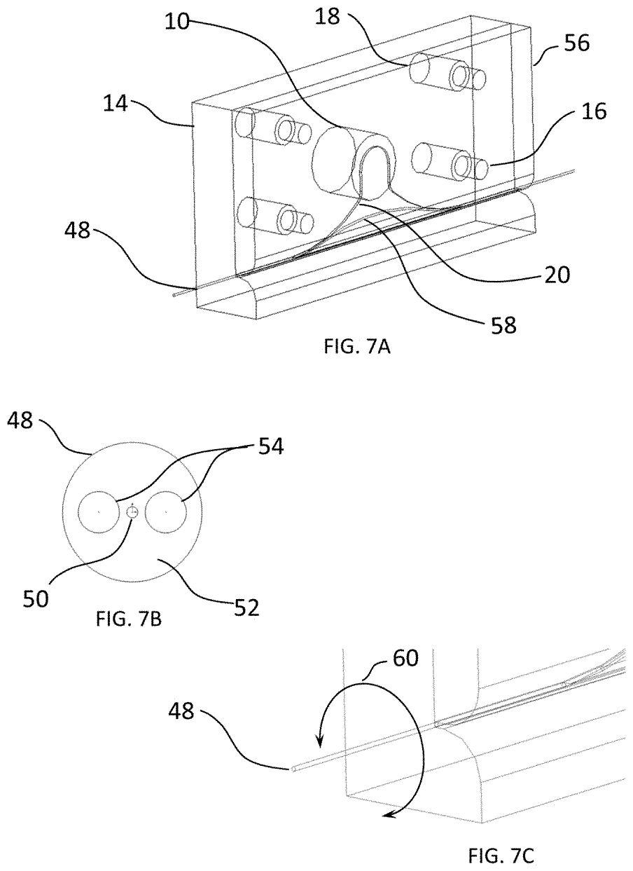

FIGS. 7A to 7C illustrate a variant of a vacuum gripper tool described in FIG. 1A to manipulate a special type of fiber known as a polarization maintaining (PM) fiber 48. A polarized fiber 48 maintains the linear polarization of light during propagation if properly launched into the fiber. The PM fiber 48 has an optical core 50, which is surrounded by stressing elements 54 within the fiber cladding 52, as shown in FIG. 7B. This specific type of polarized fiber 48 is referred to as a PANDA type. Other polarized fibers exist of various constructions (elliptical core, bow-tie, etc.). Regardless of construction, these PM fibers 48 need to be rotational oriented to the waveguide 78 on the photonic integrated circuit 44 when optically coupled. The tool may be constructed as the type shown in FIG. 1A with a parabolic fiber datum shim, front plate 12 and rear cover 14, however since only one polarized fiber 48 is handled at a time, the parabolic vacuum channel feature can be milled directly into the front plate 56. The parabolic recessed vacuum channel feature in the front plate 56 is fed by a vacuum port 10. The front plate with the parabolic recessed vacuum channel feature if attached to the rear plate with mechanical fasteners via clearance holes 18 and tapped holes 16. When vacuum is applied, the PM fiber 48 is pulled into the parabolic vacuum channel in the front cover and is deflected by the pressure difference and takes the shape of the deflected optical fiber 58 shown in FIG. 7A. In the deflected state, by rotating the vacuum gripper tool about the PM fibers axis 60, torque is transmitted to the PM fiber 48, as shown in FIG. 7C. In this way, the PM fibers 48 rotationally align stressor elements 54 to the photonic integrated circuit waveguide 78. After the fiber is optically coupled or bonded to a photonic integrated chip, turning off the vacuum gently releases the fiber from the vacuum gripper tool.

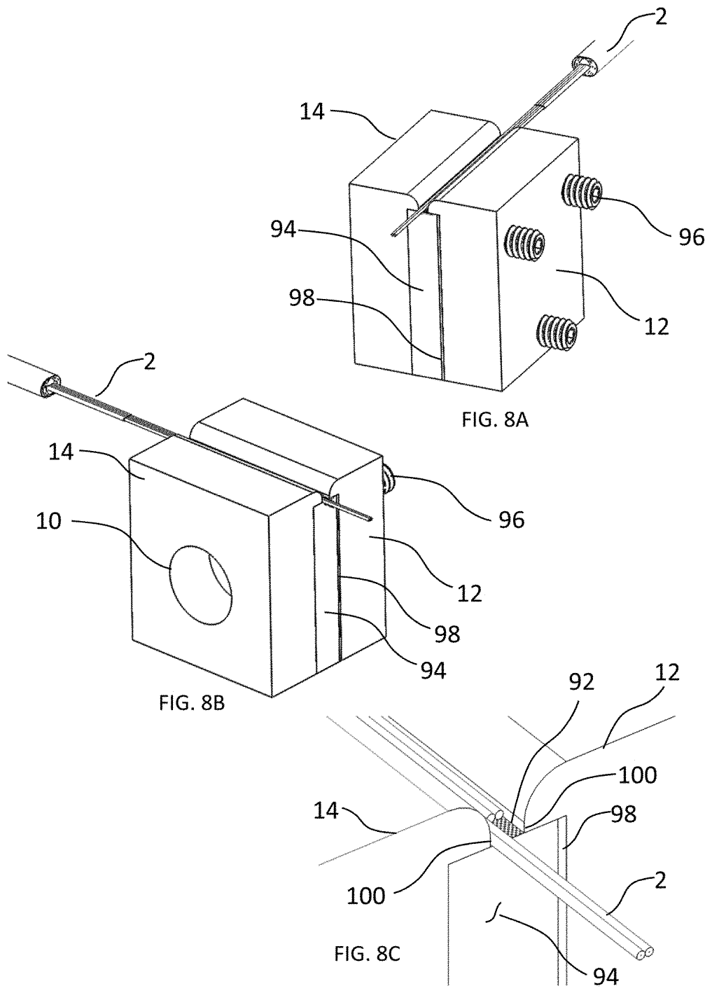

FIGS. 8A to 8C illustrate a variant of vacuum gripper tool described in FIG. 1D. In FIG. 1D, multiple fibers immediately adjacent to one another rather than spaced, are held on a single fiber datum shim 4 on the vacuum datum surface 24 via vacuum passage 20 and vacuum port 10. Fiber datum shim 4 of a thickness equal to the fiber 2 diameter times the number of desired fibers is used. This embodiment replaces this fiber datum shim 4 with a porous material. The porous material three nonfunctional edges 94 are sealed and the fourth edge is the porous media fiber datum surface 92 on which the fibers 2 are referenced when vacuum is applied through port 10. The front 12 and rear 14 plates include fiber width defining datum surfaces 100 that may be adjusted by fine pitch gap setting screws 96. The gap setting shim 98 is used to adjust the gap between the width defining datum surfaces 100 for the number of fibers 2 desired, and the gap setting screws 96 provide fine tuning.

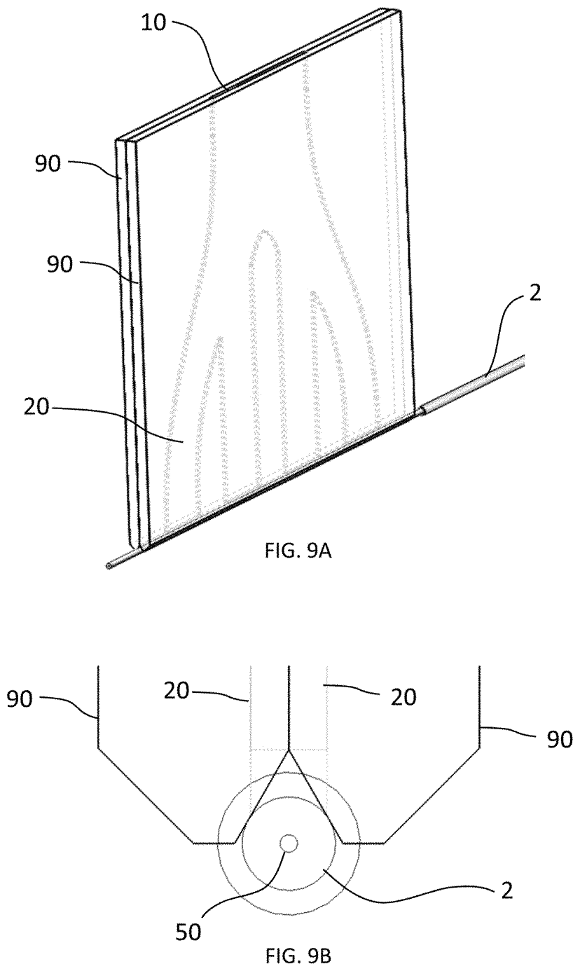

FIGS. 9A and 9B illustrate an embodiment of a fiber vacuum gripper to attach an optical fiber to a hard to access photonic integrated chip 44 within an electronic package 46. It is possible for the vacuum gripper thickness to be only four times the optical fiber 2 diameter. The tool may be fabricated in numerous ways. Similar to that shown in FIG. 1A, by laminating three shims, the outer two thin shims replace front 12 and rear 14 plates, and the center laminated shim is similar to a fiber datum shim 4, which contains the vacuum passages 20 fed by one or more vacuum ports 10. The preferred manufacturing embodiment shown in FIGS. 9A and 9B is fabricated from two narrow pick tool halves 90, with vacuum passages 20 etched by a photo fabrication process into pick tool halves 90. The two narrow pick tool halves 90 are laminated together with adhesive or by other methods that don't occlude the vacuum port 10 or vacuum passages 20. The etched vacuum passages 20 form factor/shape would terminate in a common vacuum port 10 in the desired location of the mating manipulator tooling. The fiber 2 end of the vacuum passages 20 geometry may be in the form of a V or U-shaped channel depending on the machining or etching applied.

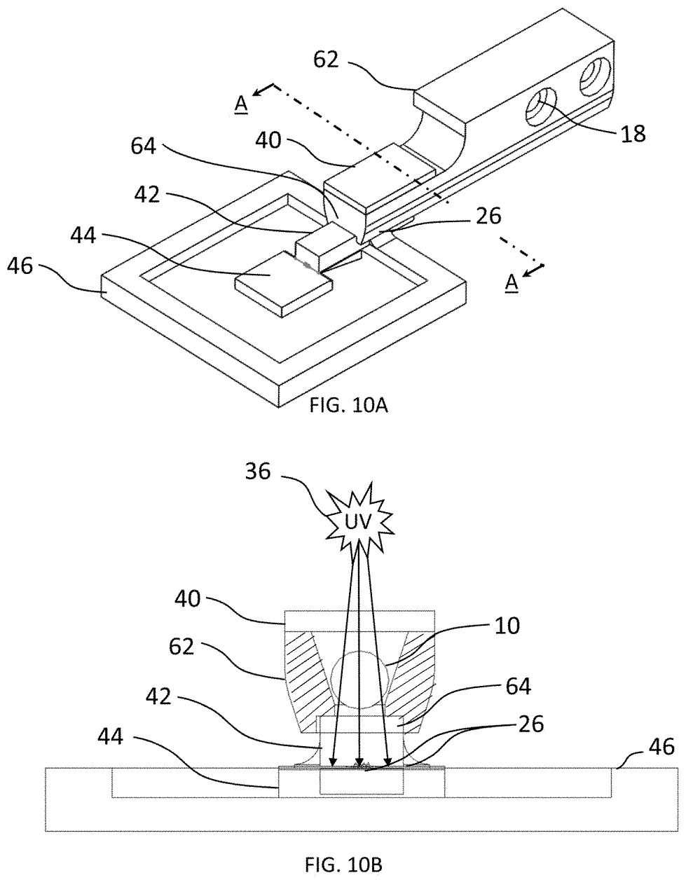

FIGS. 10A and 10B illustrate a vacuum gripper to hold a fiber array 42. The most common approach for attaching fibers or fiber arrays to chips is with a UV curable adhesive. Most commercially available fiber arrays 42 are made of quartz or other transparent glass materials. The fiber array vacuum chuck 62 includes an integrated glass window 40 that allows the UV light 36 to transmit through the gripper assembly 62. Although the fiber array vacuum chuck 62 can hold non transparent fiber arrays 42, if the fiber array 42 is of the glass type, the integrated glass window 40 allows the UV light 36 to transmit through both and reach the adhesive 26 holding the fiber array 42 to the integrated photonic chip 44 and electronic package 46 once aligned. Traditional grippers are large and bulky and shadow a majority of the adhesive 26, limiting UV light 36 exposure to the sides of the fiber array 42. Uneven curing of the adhesive 26 can move the fiber array 42 from optimal optical coupling. By curing the adhesive 26 directly below the fiber array 42, no rotational torque results from uneven curing of the adhesive on the sides of the array, which can be a secondary operation. Looking at section view 10B, the vacuum is supplied to the fiber array vacuum chuck 62 by internal vacuum port 10. The vacuum channel is enclosed on the top by the integrated glass window 40 and is closed when the quarts fiber array 42 is placed in the fiber array nesting socket 64 on the bottom. The fiber array vacuum chuck 62 is held to a manipulator by clearance holes 18 and supplies vacuum to vacuum port 10.

Photoetching is commonly used to make parts using thin metal sheets of precision thickness. The photo fabricated components can have: etched fiducials, foldable features for aiding alignment or adding desired stiffness, openings for vacuum to hold down components (such as the PIC chip) and half etched features to control adhesive migration. The photoetching of the features can be made with metals with a CTE (coefficient of thermal expansion) well matched to silicon and glass. Simplified, the photo fabrication process takes precision cleaned coils or sheets of the desired metal substrate and laminates the top and bottom surface with photosensitive laminate films. The top and bottom films are imaged by precisely register photomasks under well control environmental conditions. These films are then exposed, baked, and rinsed. The now patterned substrate is subjected to multiple chemical etching steps under precise process control. Where features are mirrored on the top and bottom image, the etching from both sides of the substrate perforate the substrate in that location. If the image feature exists on only one side, the feature is only etched from one side and its depth is controlled by the etch process parameters. This “half etching” of the substrate creates precise features like, fiducials and trenches of many uses like hinge lines where single components may be folded.

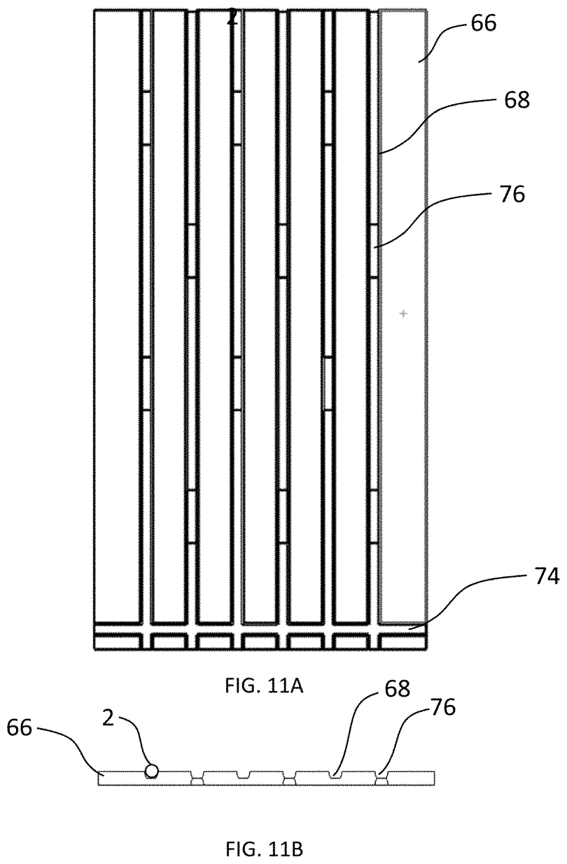

FIGS. 11A and 11B show some specific fundamental implementations which include: etched grooves to precisely space multiple fibers together. The fibers are easily populated into a pattern with the aid of vacuum slots. Once populated, the top surface may be “glob topped” with adhesive creating a ribbon of fibers at the desired pitch. The fibers of the assembly are then cleaved by mechanical or laser procedures. A preferred embodiment is to cleave the position of the fiber ends to a datum feature that is formed or etched into the base part.

The etched grooves to precisely space multiple fibers are half etch features 68. Where two half-etch features 68 intersect, openings through the photo fabricated substrate 66 form intersecting half etch features 76. These intersecting half-etch features 76 act as vacuum passages to hold fibers 2 into the half etch features 68 that precisely maintain multiple fibers 2 at the desired pitch.

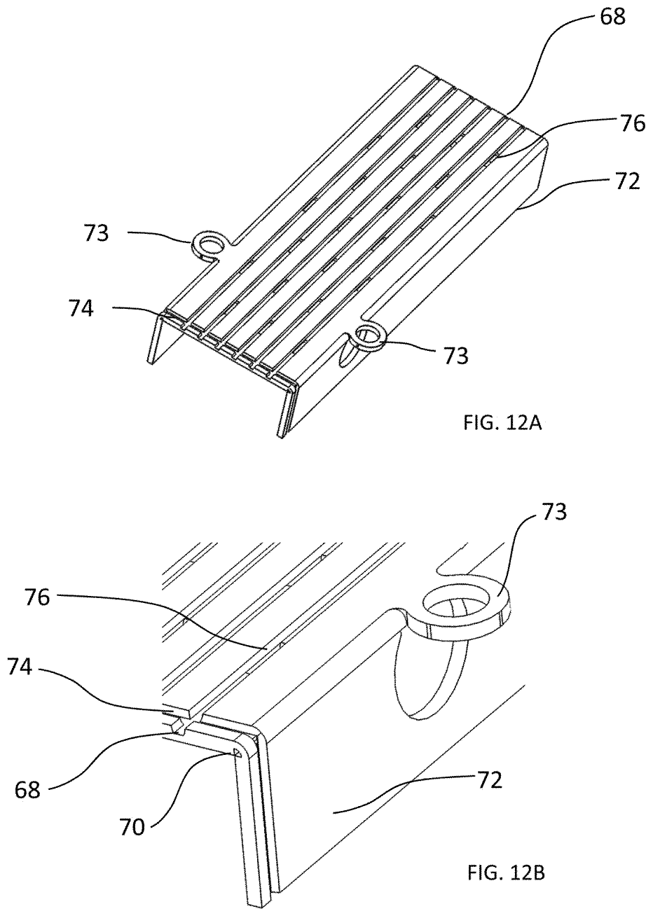

FIGS. 12A and 12B show the endless embodiments of these photo fabricated features. Stiffener feature 72 is formed by bending a half etch features 68 ninety degrees resulting in foldable hinge line 70. Although simply a half etch feature 68, it may be implemented as a locating/pivot/mounting feature 74 datum resulting from the precision inherent in the photo fabrication process. FIGS. 12A and 12B also show a single embodiment of a through etch locating/pivot/mounting Feature 73.

Optical fibers have a well-defined and controlled diameter. Consequently, they can be used to determine a predictable distance to waveguides on a PIC chip. Furthermore, the waveguides on the PIC chip are at a precise distance bellow top surface of the chip. Consequently, with precisely controlled spacers it is possible to determine the relative position of an optical fiber assembly relative to the waveguides on the chip. In this method glass beads are used, which are commonly used to define adhesive bond lines in many industries. These spheres could be of any material if of consistent size: Metal for induction heating to cure adhesive, polymeric to take advantage of compressibility and high shrink rate of an adhesive to slowly cure and compress the spheres to tune in the optical connection. To facilitate the assembly process described above, configurations of fiber ribbons or arrays are required that reference the fibers 2 outer diameter to the fiber datum surface 24 of a generic flat array/ribbon coupon 28. An embodiment of this type of fiber ribbon or array was shown in FIG. 4A and was fabricated with a ribbon forming fixture 32.

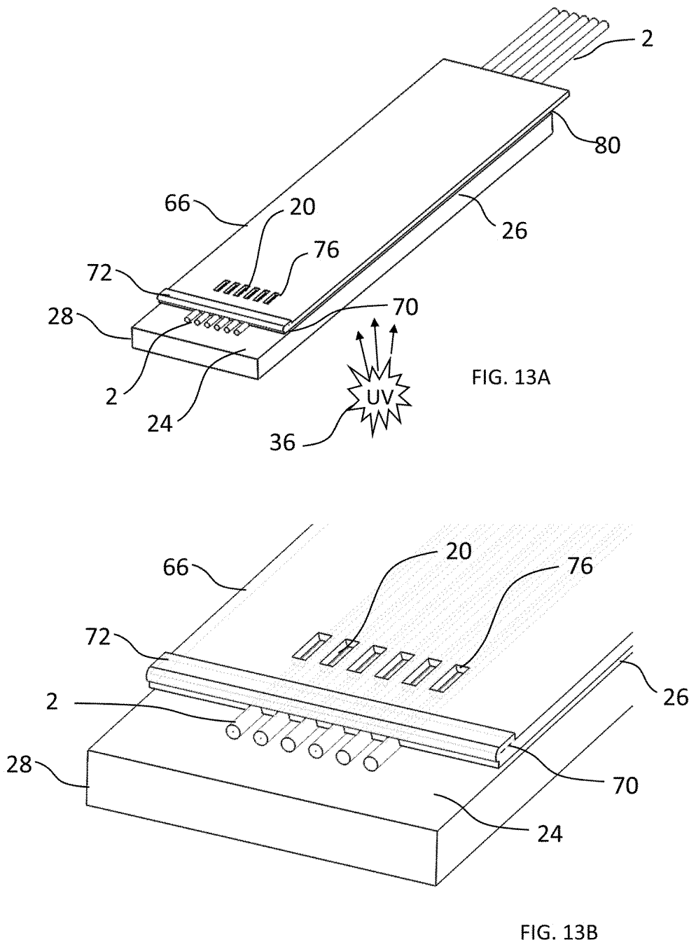

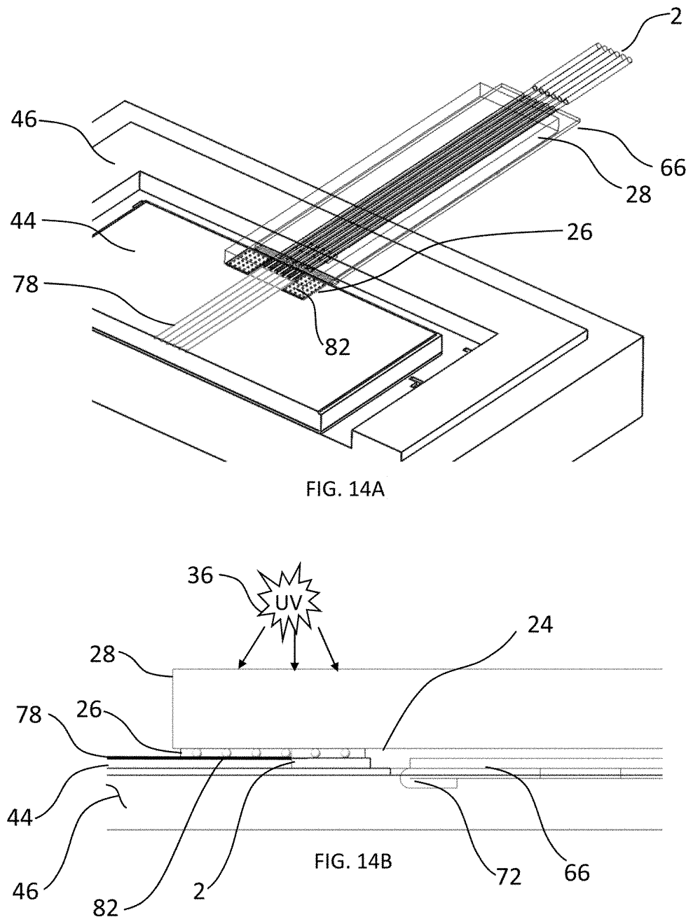

FIGS. 13A and 13B show an embodiment of this type of fiber ribbon or array where a photo fabricated substrate 66 is an integral part of the fiber ribbon or array, replacing the ribbon forming fixture 32 to precisely position the fibers 2. Vacuum passages 20 hold the fibers 2 into the half etch features 68 acting to precisely position the lateral spacing of the fibers 2. The fibers 2 outer diameters are then brought into contact with the fiber datum surface 24 of the generic flat array/ribbon coupon 28. Capillary action or by vacuum assist, adhesive 26 is introduce in between the surfaces and cured by UV light emission 36. This embodiment also shows a stiffener feature 72 defined by a foldable hinge line feature 70 on the photo fabricated substrate 66.

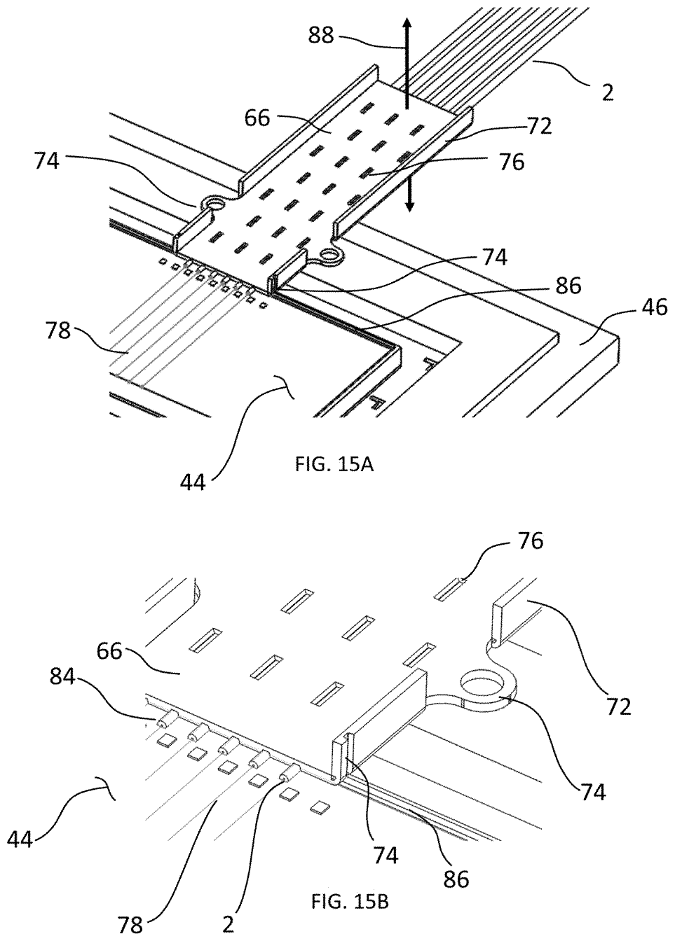

FIGS. 14A and 14B illustrate the implementation of the micro spheres 82 to precisely control the vertical location of the optical core 50 of the fiber 2 to the photonic integrated circuit waveguide 78 of the photonic integrated chip 44. Since the well-defined and controlled diameter of the fiber 2 is in contact with the fiber datum surface 24 of the generic flat array/ribbon coupon 28, and the depth of the photonic integrated circuit waveguides 78 below the surface of the photonic integrated chip 44 is also precisely know, the diameter of the micro spheres 82 may be easily calculated. Micro spheres 82 of the required size are added to adhesive 26 to passively define the vertical position when optical coupling the fiber ribbon or array. Once optical coupled laterally, the adhesive 26 is cured with UV light emission 36. These micro spheres 82 may be combined with other features such a U-channels etched in the photonic integrated chip 84 (shown in FIGS. 15A and 15B) which define the fiber ribbon or arrays lateral position for a true passive coupling of a fiber ribbon or array.

FIGS. 15A and 15B illustrates a photo fabricated package incorporating a pivot feature which can be used to make very small vertical adjustments of the fibers relative to the waveguide using the coarse motion of assembly equipment. A fiber ribbon or array where a photo fabricated substrate 66 is an integral part of the fiber ribbon or array has a locating/pivot/mounting feature 74 which mates to a corresponding photonic integrated chip pivot feature 86. The photonic integrated chip 44 also includes U-channel features 84 at the desired fiber 2 spacing whereas each U-channel 84 is centered laterally on a photonic integrated circuit waveguide 78. The U-channels 84 lateral position relative to the photonic integrated circuit waveguide 78 can be held very precisely since they are created by a micro-lithography process. Due to manufacturing limitations however, the depth of the U-channel features 84 cannot be held within a required 1 micron positional accuracy. During optical coupling of the fiber ribbon or array which has fibers 2 pre-attached to the photo fabricated substrate 66, the fibers 2 are placed into the mating U-channel features 84, precisely locating the fiber ribbon or array laterally along the photonic integrated chip 44 and centering each fiber 2 to their corresponding photonic integrated circuit waveguide 78. Simultaneously, by mating the locating/pivot/mounting feature 74 of the photo fabricated substrate 66 to the corresponding photonic integrated chip pivot feature 86, the nominal setback distance of the face of the fiber 2 to the face of the photonic integrated circuit waveguide 78 is achieved. At this point, only the vertical alignment of the fiber 2 to the photonic integrated circuit waveguide 78 needs to be accomplished. The fulcrum point of the mating pivot features places the fibers 2 at a close to the required vertical height. Due to the relatively large acceptance angle tolerance of the light into the photonic integrated circuit waveguide 78, by pivoting the photo fabricated substrate 66 about the mated locating/pivot/mounting feature 74 with a macro manipulator motion 88, one can precisely align the vertical position of the fibers 2 to the photonic integrated circuit waveguides 78. This is accomplished by taking advantage of the short lever distance from the fiber face 2 to the fulcrum (mated pivot features), and the relatively longer lever distance to the application of the macro manipulator motion 88 on the photo fabricated substrate 66. Although not shown in the figures, once optical coupling is optimized, the area may be potted with optical index matching adhesive.

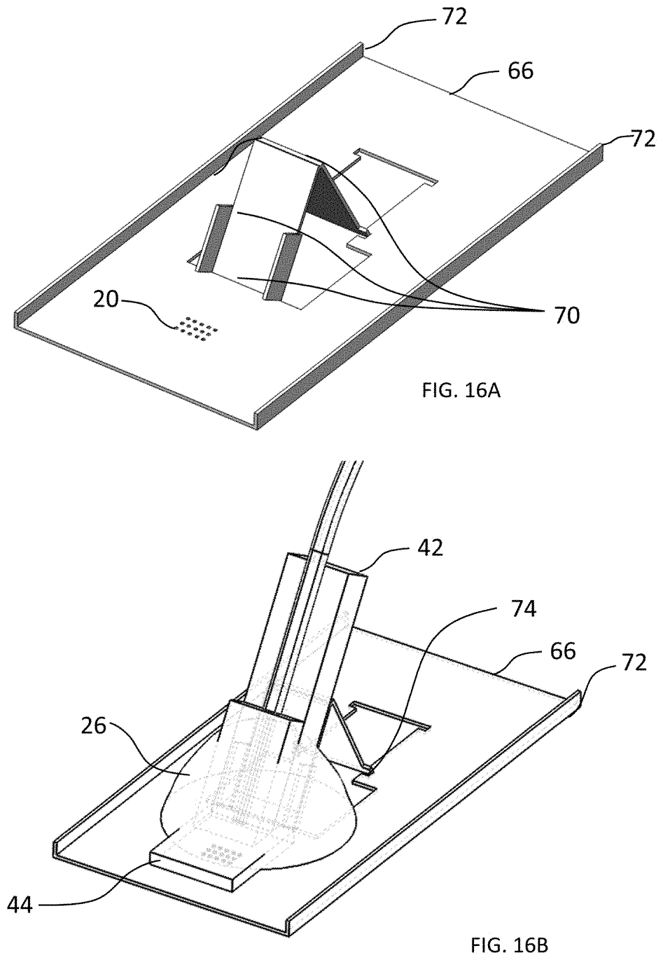

FIGS. 16A and 16B illustrate a photo fabricated substrate 66 formed into a 3D structure for a fiber array 42 grating packaging solution. Typically, the integrated photonic chips 44 are much smaller than the fiber arrays 42 optically coupled to them. This puts a lot of stress on the integrated photonic chips 44 packaging. By taking advantage of the attributes of the photo fabrication process, a skeletal backbone can be made of low CTE metals to enhance the assembly process and the robustness of the overall finished assembly. In this embodiment, after photo fabricating the substrate 66, it is formed into the 3D structure shown in FIG. 16A. This is accomplished by forming the foldable hinge line features 70 and position the locating/pivot/mounting features 74 to achieve the final desired shape. During assembly, this photo fabricated structure 66 can be placed on a ported vacuum chuck using vacuum passages 20 as locating fiducials. Not shown in this embodiment, half-etch fiducials or targets of any type may be incorporated into the photo fabricated substrate 66. Then using the same vacuum passages 20 as locating fiducials, the photonic integrated chip 44 may be precisely placed on the photo fabricated substrate 66 and retained in position when vacuum is applied to the vacuum passages 20. The fiber array 42 is then passively positioned into its socket on the folded photo fabricated substrate 66. Once proper optical coupling is verified, the entire structure is potted in adhesive 26. The surrounding undefined geometry of the photo fabricated substrate 66 may be used to anchor/mount the finished assembly to other components/packaging transferring any mechanical stress and thermal gradients into the common structure.

Although various embodiments have been depicted and described in detail herein, it will be apparent to those skilled in the relevant art that various modifications, additions, substitutions, and the like can be made without departing from the spirit of the disclosure and these are therefore considered to be within the scope of the disclosure as defined in the claims which follow.

What is claimed:

1. An optical fiber vacuum gripping tool, comprising:
a first side plate comprising a first planar edge surface and a first planar side surface, wherein the first planar side surface comprises a first at least one vacuum passage disposed therein and a first fiber datum edge surface, the first at least one vacuum passage having a first at least one vacuum passage opening at the first fiber datum edge surface;
a second side plate comprising a second planar side surface adjacent the first planar side surface and a second planar edge surface aligned with the first planar edge surface; and
a first at least one vacuum source port in fluid communication with the first at least one vacuum passage and disposed in at least one of the first side plate and second side plate, wherein the first fiber datum edge surface is recessed below the aligned first and second planar edge surfaces.

2. The device of claim 1, further comprising a) a first spacer shim having a third planar side surface, a third planar edge surface and a second at least one vacuum source port, the third planar side surface disposed between the first and second planar side surfaces, wherein the second at least one vacuum port is in fluid communication with the first at least one vacuum passage and the third planar edge surface is aligned with the aligned first and second planar edge surfaces, and b) a first fiber datum shim comprising a fourth planar side surface disposed between the second and third planar side surfaces, a second at least one vacuum passage disposed therein and a second fiber datum edge surface, the second at least one vacuum passage having a second at least one vacuum passage opening at the second fiber datum edge surface, wherein the second at least one vacuum source port is in fluid communication with the second at least one vacuum passage, and wherein the second fiber datum edge surface is recessed below the aligned first, second and third planar edge surfaces.

3. The device of claim 2, further comprising at least one paired component disposed between the second and fourth planar side surfaces, wherein the at least one paired component comprises the first spacer shim and first fiber datum shim.

4. The device of claim 1, wherein the first planar side surface of the first side plate comprises a first fiber datum shim as a separate component from the first side plate, wherein the first fiber datum shim comprises the first planar side surface comprising the first at least one vacuum passage disposed therein and the first fiber datum edge surface.

5. The device of claim 4, further comprising a) a first spacer shim having a third planar side surface, a third planar edge surface and a second at least one vacuum source port, the third planar side surface disposed between the first and second planar side surfaces, wherein the second at least one vacuum port is in fluid communication with the first at least one vacuum passage and the third planar edge surface is aligned with the aligned first and second planar edge surfaces, and b) a second fiber datum shim comprising a fourth planar side surface disposed between the second and third planar side surfaces, a second at least one vacuum passage disposed therein and a second fiber datum edge surface, the second at least one vacuum passage having a second at least one vacuum passage opening at the second fiber datum edge surface, wherein the second at least one vacuum source port is in fluid communication with the second at least one vacuum passage, and wherein the second fiber datum edge surface is recessed below the aligned first, second and third planar edge surfaces.

6. The device of claim 5, further comprising at least one paired component disposed between the second and fourth planar side surfaces, wherein the at least one paired component comprises the first spacer shim and second fiber datum shim.

7. The device of claim 4, wherein the first fiber datum shim comprises a vacuum porous material.

8. The device of claim 1, wherein the first fiber datum edge surface comprises a width which accommodates multiple adjacent fibers.

9. The device of claim 4, wherein the first fiber datum edge surface comprises a width which accommodates multiple adjacent fibers.

10. The device of claim 9, wherein the first fiber datum shim comprises a vacuum porous material.

11. The device of claim 5, further comprising:
an integrated ribbon substrate recess;
a removeable ribbon coupon disposed in the recess; and
a UV transparent recess cover.

12. The device of claim 11, wherein the first and second fiber datum edge surfaces comprise a fiber spacing feature comprising a plurality of parallel grooves spaced apart at a desired pitch or a loading fin alignment.

13. A multiple fiber ribbon, comprising:
a flat datum surface of the multiple fiber ribbon comprising precision microspheres disposed in the adhesive of the fiber array defining an optical fiber axis from the datum surface having a diameter which matches a mating component of a photonic integrated chip vertically aligning the optical fiber axis.

14. A method for aligning and attaching optical fibers to a photonic integrated chip, comprising:
loading a gripper tool with a plurality and spacing of fibers matching the number and spacing of waveguides on a photonic integrated chip;
retaining a precise position of the fibers on the tool by vacuum;
monitoring the coupling of light between the optical fibers and the photonic integrated chip;
manipulating the position of the optical fibers axis and faces in proximity with the optical axis of the waveguides on the photonic integrated chip; and
optically coupling the fibers using feedback from the monitoring.

15. A method for forming an optical fiber array, comprising:
loading a plurality of optical fibers into locating features on a ribbon forming tool comprising a coupon component;
retaining the loaded optical fibers in the coupon component of the ribbon forming tool by vacuum at a precise spacing and planarity of the optical fibers;
applying an adhesive material to the optical fibers retaining their relative position forming a fiber optic ribbon array; and
cleaving the fibers of the ribbon array at an optical interface of the optical fibers.

16. An optical fiber vacuum gripping tool, comprising:
a first side plate including a first planar edge surface and a first planar side surface;
a first fiber datum shim including at least one vacuum passage disposed therein, a second planar side surface adjacent the first planar side surface and a first fiber datum edge surface, the first at least one vacuum passage having a first at least one vacuum passage opening at the first fiber datum edge surface;
a second side plate including a third planar side surface adjacent the second planar side surface and a second planar edge surface aligned with the first planar edge surface; and
a first at least one vacuum source port in fluid communication with the first at least one vacuum passage and disposed in at least one of the first side plate and second side plate, wherein the first fiber datum edge surface is recessed below the aligned first and second planar edge surfaces.

17. A method for photo fabrication of an array of optical fibers, comprising:
precision cleaning a metal substrate in the form of a single sheet or a roll;
laminating with a photoresist material on one or both planer surfaces of the metal substrate;
positioning photo tool masters of the desired components geometry, opposite one or both planar surfaces of the photo-resist laminated metal;
precisely aligning the photo tools via integral fiducials and the desired components geometry then imaged (exposed) on one or both planar surfaces of the metal substrate being processed;
developing and baking the laminated photoresists on the metal substrate resulting in photoresist protecting the metal substrate in areas of the desired components geometry;
subjecting the laminated metal substrate to an etching process, attacking the unprotected base metal wherein opposing un-protected regions existing on both planar surfaces of the substrate, and etching from both sides, eventually perforating the metal substrate in that region; and
retaining small sprue-like features around the perimeter of the desired geometry to retain the component in the sheet or roll of metal substrate to be broken out at a later time, wherein when only one side of the substrate has an un-protected region, only etching from that side and its penetration depth determined by the time exposed to the etching process resulting in a half etch feature in the metal substrate.

18. A method for passive alignment and attachment of an optical fiber array to a photonic integrated chip, comprising:
incorporating a plurality of microspheres in the adhesive of an optical fiber array where a surface of the circumference the optical fibers is in intimate contact with a flat surface, defining the fibers optical axis plane parallel to that flat surface by the inherent precision of the optical fibers diameter when forming the optical fiber array, the optical fibers in the array have an axis parallel in one plane and precisely spaced by the features of the array forming fixture in another plane;
aligning the optical fibers with waveguides of a photonic circuit residing at a precise distance below the surface of the chip; and
optically coupling these optical axis features in the vertical plane passively making the connection of the fiber array to the photonic integrated chip.
